(19) United States
(12) Patent Application Publication
(10) Pub. No.: US 2002/0195094 A1
(43) Pub. Date: Dec. 26, 2002

(54) Crawl wall saw

(76) Inventor: William M. Crawford, Glen St. Mary, FL (US)

Correspondence Address: Jeffrey C. Maynard, 325 Creswell Road, Severna Park, MD, 21146, US

(21) Appl. No.: 10/176,420

(22) Filed: Jun. 20, 2002

Related U.S. Application Data
(60) Provisional application No. 60/299,596, filed on Jun. 20, 2001.

(51) Int. Cl. B28D 1/04

(52) U.S. Cl. 125/13.01; 125/13.03; 125/14

(57) ABSTRACT

An apparatus and process for cutting a precise even groove into a concrete wall for tilt-up roof panel installation. The apparatus includes a platform assembly to which a saw assembly is mounted. The platform assembly includes at least one forwardly projecting roller wheel firmly biased against the top surface of a concrete wall and at least two vertically suspended guiding roller wheels. The platform assembly rolls across the top surface of a concrete wall to guide and support the attached saw frame, which holds a concrete, saw motor and a saw blade at a desired angle.

### BACKGROUND OF THE INVENTION

1. Field of the Invention

This invention relates generally to concrete saws, and more particularly to an apparatus for generating precise, even grooves in a concrete wall for ease of tilt-up roof panel installation.

2. Background of the Prior Art

Current apparatuses for cutting grooves in a concrete wall for tilt-up roof panel installation are hand held, such as a power cutting saw. Often, when using such an apparatus, the grooves are imprecise in angle and not perfectly straight, due to general human error, thereby making it very difficult to install tilt-up roof panels. As is often the case, such apparatuses are also bulky and difficult to manage, thereby making the process for cutting even grooves both time consuming and labor intensive.

Consequently, there exists an unfulfilled need for an apparatus and process for cutting precise, even grooves in a concrete wall for ease of tilt-up roof panel installation.

### SUMMARY OF THE INVENTION

The present invention provides such an apparatus and process for cutting precise, even grooves in a concrete wall. Specifically, the present invention enables the efficient cutting of precise, even grooves into a concrete wall, at any angles, while requiring little physical labor. The invention includes a platform assembly to which a saw assembly is mounted. The platform assembly includes at least one forwardly projecting roller wheel firmly biased against the top surface of a concrete wall and at least two vertically suspended guiding roller wheels. The platform assembly rolls on the top surface of a concrete wall to guide and support an attached saw frame that holds a saw motor and a concrete saw blade at a desired angle for cutting a groove into the side of the wall.

First, the platform assembly is placed on the top surface of a concrete wall, with all roller wheels firmly biased against the top and side surfaces of the wall. Next, the saw blade is adjusted to a selected angle. Then, the position of the saw frame is adjusted to place the saw blade flush against the surface of the wall in a position where a groove is to be cut. Finally, the motor is activated to operate the saw blade. The platform assembly is manually moved along the upper surface of the concrete wall to cause the saw blade to cut a groove along the sidewall surface.

An object of the invention is to enable the cutting of precise, even grooves in a concrete wall in a labor and time efficient manner.

Another object of the invention is to provide a more efficient means for installing tilt-up roof panels.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 illustrates a perspective view of an assembly of the apparatus according to the present invention;

FIG. 2 illustrates an enlarged perspective view of the bottom portion of a frame assembly according to the present invention; and

FIG. 3 illustrates an enlarged side view of a frame assembly according to the present invention.

### DETAILED DESCRIPTION

The invention summarized above and defined by the enumerated claims may be better understood by referring to the following detailed description, which should be read in conjunction with the accompanying figures. This detailed description of a particular preferred embodiment, set out below to enable one to practice the invention, is not intended to limit the enumerated claims, but to serve as a particular example thereof. Those skilled in the art should appreciate that they can readily use the concepts for the wall saw and the specific embodiments disclosed as a basis for modifying or designing other methods and systems for carrying out the same purposes of the present invention. Those skilled in the art should also realize that such equivalent methods and systems do not depart from the spirit and scope of the invention in its broadest form.

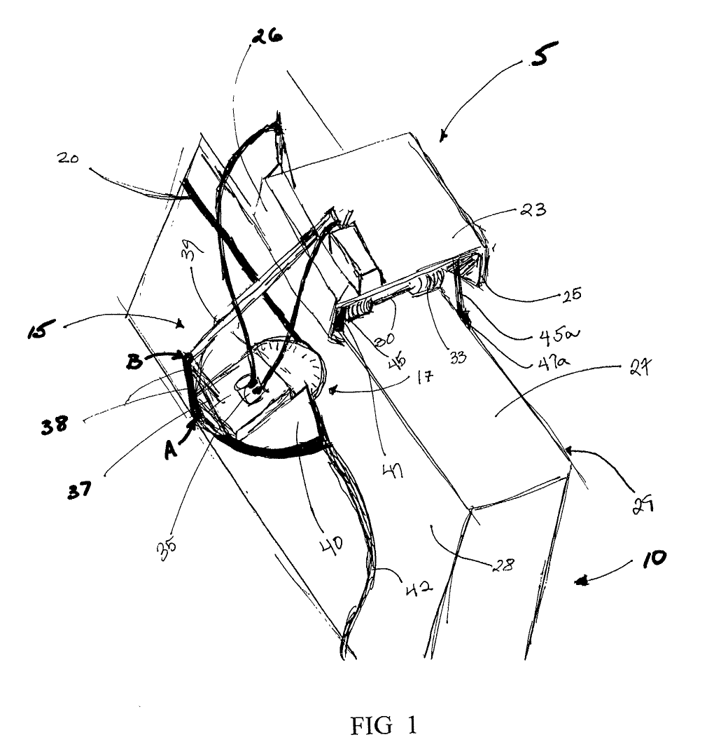

An assembly according to the present invention, for cutting an angled groove along a concrete wall is shown in perspective view in FIG. 1. The apparatus includes a platform assembly 5 atop a wall 10 and a saw assembly 15. A saw 17, adjustable to a selected angle, forms a groove 20 in wall 10.

The platform assembly 5 includes a frame 23 that supports saw assembly 15. Frame 23 presents two rigid, downwardly projecting tabs 25, 26 along the sides of such frame. At least one longitudinal bar 30 is coupled securely at both ends to tabs 25, 26. Longitudinal bar 30 extends transversely through frame 23. Longitudinal bar 30 preferably mounts at least one forwardly projecting roller wheel 33 that is normally firmly biased against top surface of concrete wall 10 during operation. Top surface 27 of wall 10 is ideally level.

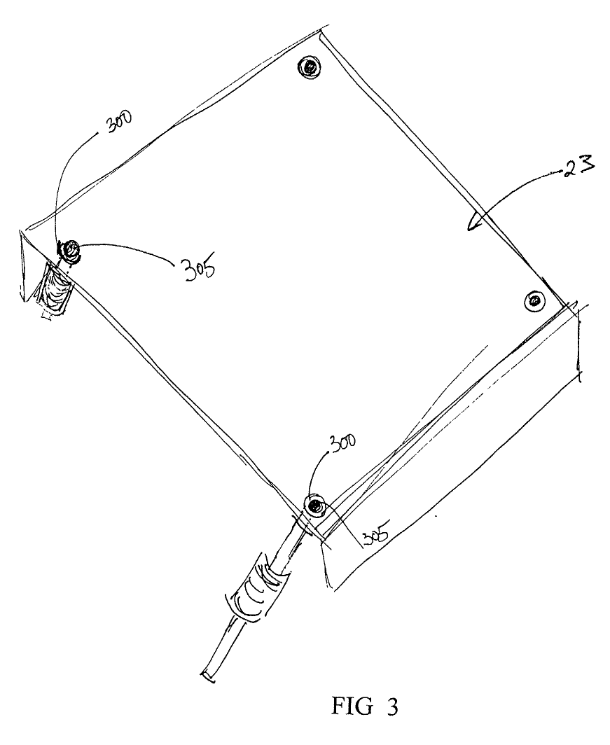

Mounted at opposite, outward side edges of frame 23 are at least two vertical bars 45, 45a. Vertical bars 45, 45a are suspended at their top ends by fasteners. In an embodiment of the present invention, stepped washers 300 and fasteners 305 are used to attach vertical bars 45, 45a to frame 23, as illustrated in more detail in the following FIG. 3.

Vertical bars 45, 45a are preferably of unequal lengths, with the vertical bar 45a located on the side of frame 23 opposite saw assembly 15 being of greater length than that of the vertical bar 45 located on the same side as the saw assembly 15. Mounted to each vertical bar 45, 45a is at least one forwardly projecting stabilizing wheel 47, 47a that is normally firmly biased against each side of wall surface 28, 29 of concrete wall 10. Such stabilizing wheels 47, 47a mounted on bars 45, 45a ensure stability and guidance to frame 23 as saw assembly 15 is operated on wall 10. Ideally, the length of the longer vertical bar 45a is determined by the weight of saw assembly 15. The present invention enables a unique method for stabilizing the platform assembly 5 by offset of the weight of the saw assembly 15 against the pressure exerted onto side wall surface 29 by stabilizing wheel 47a mounted to the longer of the vertical bars 45a.

The saw assembly 15 has a motor 35, which is shown as a hydraulic motor but may be powered by a variety of methods including, electricity, air, or the like. Motor 35, which supports and propels saw blade 17, is mounted on an adjustable frame 37, which is coupled to a support rod 38. Support rod 38 is coupled to primary support arm 39. Adjustable frame 37 is vertically adjustable by tightening or loosening a first adjustment means, such as a screw attached to support rod 38, such as at location A. Frame 37 is also horizontally adjustable by tightening or loosening a second adjustment means, such as a screw attached to the coupling joint of support rod 38 and primary support arm 39, such as at location B. By adjusting the screw attached to support rod 38 at location A, frame 37 may be adjusted to a plurality of angles as required for groove cutting. By adjusting the screw attached to the coupling joint of support rod 38 and primary support arm 39 at location B, frame 37 may be adjusted to position saw blade 17 against sidewall surface 28 for cutting groove 20. Saw blade 17 preferably has a saw guard 40 that may be fitted with a pair of water hose fittings 42, which are conventional in cutting concrete.

In operation, platform assembly 5 is lifted onto wall 10, with forward roller wheel 33 and stabilizing wheels 47, 47a firmly biased against wall top surface 27 and side surfaces 28, 29. Then, the angle of saw blade 17 is adjusted by loosening the first adjustment means attached to support rod 38 at location A and setting the frame 37 to the desired angle. Once saw blade 17 is at an appropriate angle, the first adjustment means is tightened and frame 37 is locked in place. Then, saw blade 17 is positioned flush against the wall side surface 28 by the second adjustment means at the coupling joint of support rod 38 and primary support arm 39, at location B. Next, a hydraulic hose is affixed to motor 35 and the motor is started. Hydraulic oil is passed through motor 35 beginning the movement of saw blade 17 into surface 28 to cut groove 20. Finally, platform assembly 5 is manually moved along the top surface 27 of the wall 10 to cut a precise, even groove 20 along the concrete wall 10.

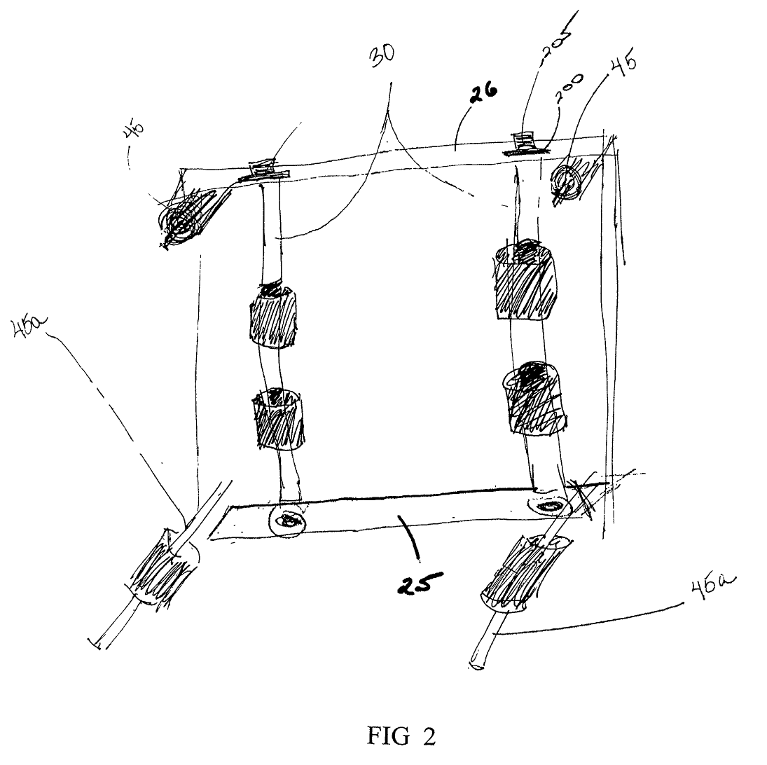

FIG. 2 illustrates an embodiment of the present invention wherein two horizontal bars 30 are coupled to tabs 25, 26 by stepped washers 200 and fasteners 205. Similarly, as illustrated in FIG. 3, four vertical bars 45, 45a are coupled to the frame 23 by stepped washers 300 and fasteners 305.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein. Therefore, for purposes of determining the scope of patent protection, reference shall be made to the appended claims in combination with the above detailed description.

What is claimed is:

1. An apparatus for cutting a groove into a concrete wall surface comprising:
(a) a platform assembly comprising a frame and vertical side tabs;
(b) at least one horizontal bar coupled to said vertical side tabs, the at least one horizontal bar further comprising at least one roller wheel;
(c) at least two vertically suspended bars mounted to opposite sides edges of said frame, each said at least two vertical bars further comprising at least one roller wheel; and
(d) a saw assembly mounted to said frame.

2. The apparatus of claim 1, wherein the saw assembly comprises:
(a) a frame;
(b) a motor mounted to said frame;
(c) a saw blade powered by said motor;
(d) a supporting rod coupled to said frame; and
(e) a primary supporting arm coupled to the supporting rod.

3. The apparatus of claim 1, wherein one of the at least two vertically suspended bars located opposite to the saw assembly is of greater length than that of the other of the at least two vertically suspended bars located on the same side as the saw assembly.

4. A process for cutting a groove at an angle into a concrete wall using the apparatus of claim 2, comprising the steps of:
(a) placing the frame onto a top surface of the concrete wall;
(b) adjusting the angle of said saw blade;
(c) adjusting the position of said saw assembly;
(d) turning on the motor to rotate the saw blade to cut a groove into the surface of the concrete wall at an angle; and
(e) manually moving the frame across the top surface of the concrete wall.
